(19) United States
(12) Patent Application Publication
(10) Pub. No.: US 2026/0319460 A1
(43) Pub. Date: Oct. 15, 2026

(54) METHOD FOR GENERATING ASSEMBLY GUIDANCE FOR PRODUCT PART ASSEMBLY DIAGRAM, ELECTRONIC DEVICE AND NON-TRANSITORY COMPUTER-READABLE STORAGE MEDIUM

(71) Applicant: Wistron Corporation, New Taipei City (TW)

(72) Inventors: CHAKRADHAR KALLE, New Taipei City (TW); JYUN HAO LAI, New Taipei City (TW); YING YUN CHANG, New Taipei City (TW); YI CHENG CHEN, New Taipei City (TW)

(21) Appl. No.: 19/295,891

(22) Filed: Aug. 11, 2025

(30) Foreign Application Priority Data
Apr. 9, 2025 (TW) 114113438

(51) Int. Cl. G05B 19/4097

(52) U.S. Cl. CPC G05B 19/4097; G05B 2219/35488

(57) ABSTRACT

A method for generating an assembly guidance for a product part assembly diagram, an electronic device and a non-transitory computer-readable storage medium are provided. The generation method includes: obtaining a product part assembly diagram and a plurality of part sample sets; inputting the product part assembly diagram, a prompt content, and the part sample sets into a large language model; and obtaining a generated content returned by the large language model, where the generated content includes an assembly guidance with a plurality of part assembly steps.

### CROSS-REFERENCE TO RELATED APPLICATION

This non-provisional application claims priority under 35 U.S.C. § 119(a) to Patent Application No. 114113438 filed in Taiwan, R.O.C. on Apr. 9, 2025, the entire contents of which are hereby incorporated by reference.

### BACKGROUND

### Technical Field

The disclosure relates to prompt engineering, and in particular to a method for generating an assembly guidance for a product part assembly diagram by using prompt engineering, an electronic device and a non-transitory computer-readable storage medium.

### Related Art

At present, before a product assembly test is carried out in a production line, it is required to write an assembly guidance in a product part assembly diagram file for assemblers to follow when carrying out the assembly operation. However, different writers have different habits, and their expressions in describing various operations are not the same, which can make it difficult for assemblers to understand when reading or cause misunderstandings. In addition, an assembly guidance needs to be written for each new product, which is labor-intensive and time-consuming.

### SUMMARY

An embodiment of the disclosure provides a method for generating an assembly guidance for a product part assembly diagram, including: obtaining a product part assembly diagram and a plurality of part sample sets; inputting the product part assembly diagram, a prompt content, and the part sample sets into a large language model; and obtaining a generated content returned by the large language model, where the generated content includes an assembly guidance with a plurality of part assembly steps.

An embodiment of the disclosure provides a non-transitory computer-readable storage medium, storing a plurality of instructions loaded to execute the method for generating an assembly guidance for a product part assembly diagram described above.

An embodiment of the disclosure provides an electronic device, including: a storage unit, an input/output unit and a computing unit. The computing unit is coupled to the storage unit and the input/output unit. The storage unit stores a plurality of part sample sets. The input/output unit obtains a product part assembly diagram. The computing unit inputs the product part assembly diagram, a prompt content, and the part sample sets into a large language model, and obtains a generated content returned by the large language model. The generated content includes an assembly guidance, and the assembly guidance includes a plurality of part assembly steps and is outputted via the input/output unit.

The method for generating an assembly guidance for a product part assembly diagram, the electronic device and the non-transitory computer-readable storage medium according to some embodiments of the disclosure can realize generation of the assembly guidance for the product part assembly diagram by using a small number of samples.

### BRIEF DESCRIPTION OF THE DRAWINGS

FIG. 1 is a schematic structural diagram of an electronic device for generating an assembly guidance for a product part assembly diagram according to an embodiment of the disclosure;

FIG. 2 is a flowchart of a method for generating an assembly guidance for a product part assembly diagram according to an embodiment of the disclosure;

FIG. 3 is a flowchart of a method for generating an assembly guidance for a product part assembly diagram according to an embodiment of the disclosure;

FIG. 4 is a schematic diagram of a product part assembly diagram according to an embodiment of the disclosure;

FIG. 5 is a schematic diagram of a prompt content according to an embodiment of the disclosure;

FIG. 6 is a schematic diagram of a generated content according to an embodiment of the disclosure;

FIG. 7 is a schematic diagram of a tree structure of candidate sample sets according to an embodiment of the disclosure; and

FIG. 8 is a flowchart of a method for generating an assembly guidance for a product part assembly diagram according to an embodiment of the disclosure.

### DETAILED DESCRIPTION

The same reference numerals in all drawings will be used to denote the same or similar components. The "including" mentioned herein is an open-ended term, so it should be interpreted as "including but not limited to". As used herein, "coupled" means that two or more components "directly" make physical or electrical contact with each other or "indirectly" make physical or electrical contact with each other.

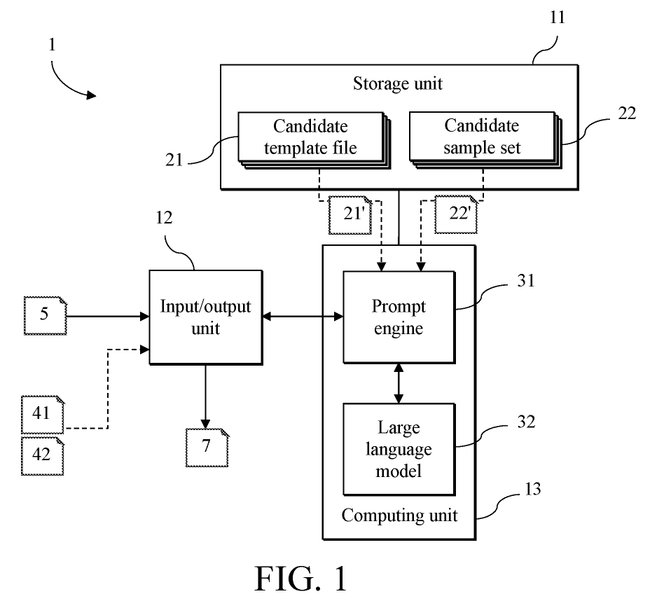

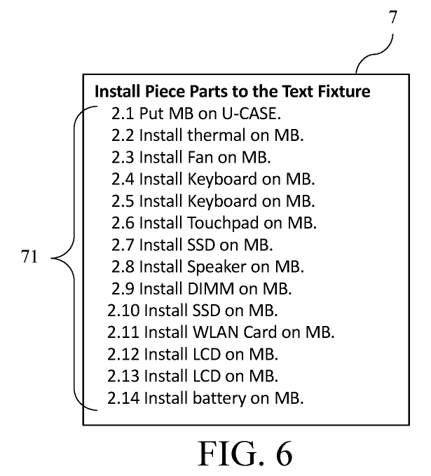

FIG. 1 is a schematic structural diagram of an electronic device 1 for generating an assembly guidance 7 (as shown in FIG. 6) for a product part assembly diagram 5 according to an embodiment of the disclosure. The electronic device 1 includes a storage unit 11, an input/output unit 12 and a computing unit 13. The computing unit 13 is coupled to the storage unit 11 and the input/output unit 12. The storage unit 11 is a non-transitory computer-readable storage medium, storing a plurality of candidate template files 21 and at least one candidate sample set 22. Each candidate template file 21 is a prompt template file 21', which records a prompt content. The prompt content of each candidate template file 21 is at least partially different for use with different products. Each candidate sample set 22 is a part sample set 22', specific content of which will be described later. The non-transitory computer-readable storage medium further stores a plurality of instructions (not shown), and the instructions are loaded by the computing unit 13 to execute a method for generating an assembly guidance 7 for a product part assembly diagram 5 and form a prompt engine 31 for providing prompt information to a large language model (LLM) 32 such that the large language model 32 outputs a generated content according to the prompt information. The generated content includes the assembly guidance 7, and the input/output unit 12 outputs the assembly guidance 7.

In some embodiments, the large language model 32 is deployed in the electronic device 1. In some other embodiments, the large language model 32 is deployed in other devices (such as a cloud server) except the electronic device 1, and the electronic device 1 exchanges information with the large language model 32 through an application programming interface (API).

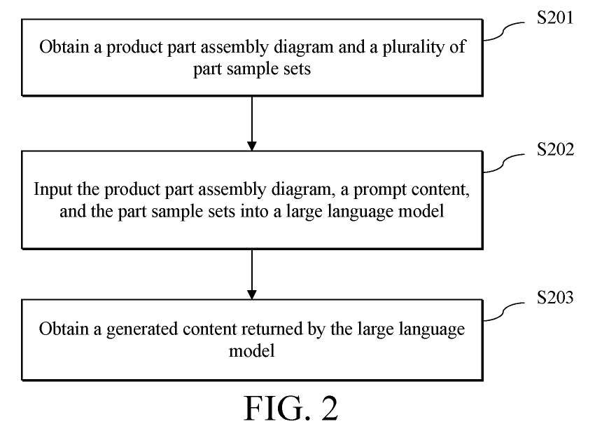

FIG. 2 is a flowchart of a method for generating an assembly guidance 7 for a product part assembly diagram 5 according to an embodiment of the disclosure. First, a product part assembly diagram 5 and a plurality of part sample sets 22' are obtained (step S201). Next, the product part assembly diagram 5, a prompt content, and the part sample sets 22' are inputted into a large language model 32 (step S202). Then, a generated content returned by the large language model 32 is obtained (step S203). The specific description is as follows.

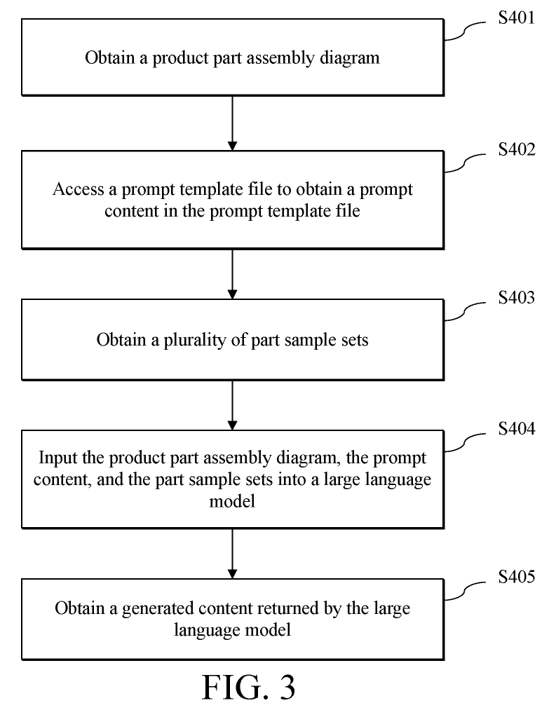

Referring to FIGS. 1 and 3, FIG. 3 is a flowchart of a method for generating an assembly guidance 7 for a product part assembly diagram 5 according to an embodiment of the disclosure. The method for generating an assembly guidance 7 for a product part assembly diagram 5 is executed by a computing unit 13 and includes steps as follows:

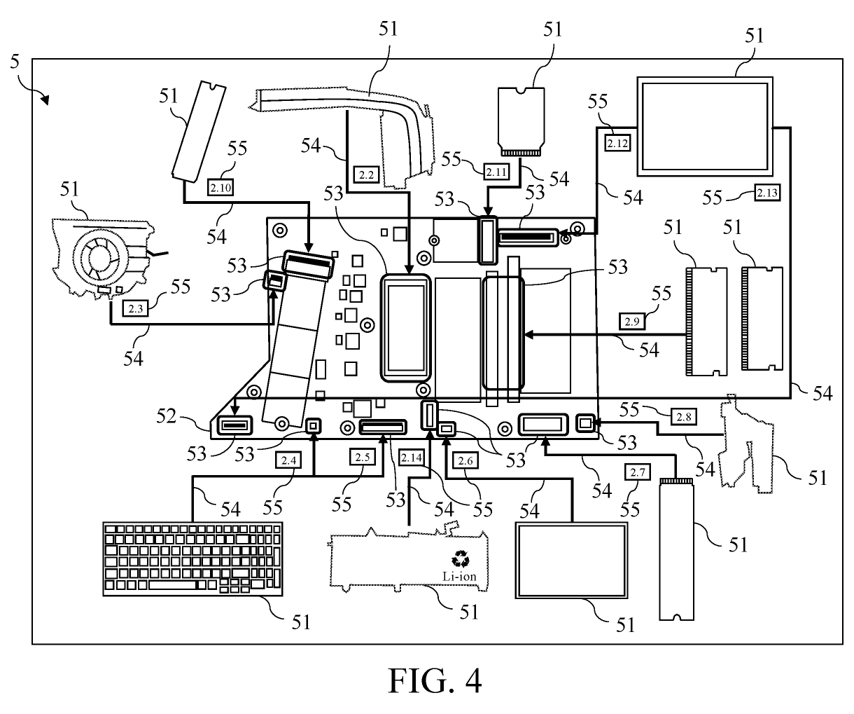

In step S401, a prompt engine 31 obtains a product part assembly diagram 5 via an input/output unit 12. FIG. 4 is a schematic diagram of the product part assembly diagram 5 according to an embodiment of the disclosure. The product part assembly diagram 5 includes a plurality of part images 51 and a motherboard image 52. Here, the product part assembly diagram 5 mentioned in FIG. 3 is a photo taken from a vertical top view angle, but the embodiments of the disclosure are not limited thereto. For example, the product part assembly diagram 5 may be taken from other non-vertical top view angles. In some embodiments, the part images 51 and the motherboard image 52 are respectively the side surface with the largest area (for example, the display surface in an example of a screen).

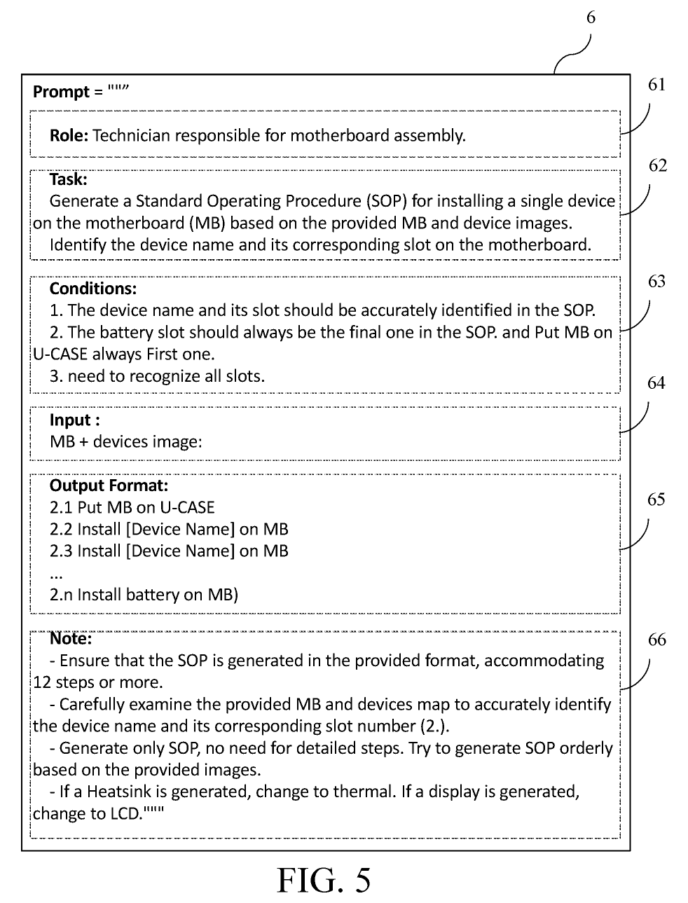

In step S402, the prompt engine 31 accesses a prompt template file 21' in a storage unit 11 to obtain a prompt content 6 in the prompt template file 21' (as shown in FIG. 5). FIG. 5 is a schematic diagram of the prompt content 6 according to an embodiment of the disclosure, which will be further described later. In some embodiments, the prompt template file 21' is one of a plurality of candidate template files 21 in the storage unit 11. That is, step S402 described above is selecting a candidate template file 21 (i.e., the prompt template file 21') in the storage unit 11 for accessing to obtain the prompt content 6 of a product suitable for the product part assembly diagram 5. Different prompt template files 21' are suitable for different products so as to provide a suitable prompt content 6 for different products. For example, a notebook computer has a battery, and a desktop computer does not have a battery, so the requirements of the corresponding prompt template files 21' in a battery installation step are different. However, the embodiments of the disclosure do not mandate this difference, nor do they limit the presence of only this difference.

In step S403, the prompt engine 31 obtains a plurality of part sample sets 22' from the storage unit 11. In some embodiments, the obtained part sample sets 22' are selected from candidate sample sets 22 in the storage unit 11. Each part sample set 22' (each selected candidate sample set 22) includes at least one part demonstration name and at least one corresponding part demonstration image as a support set of few shot learning, which is generally called N-way K-shot. "Way" is the category, and "shot" is the sample of each category. That is, there are N categories in each part sample set 22' (each candidate sample set 22), and there are K samples in each category. N and K are positive integers greater than or equal to one. The part demonstration name is specifically a part category, such as Fan, Memory, Hard disk, Network card and Screen. The part demonstration image is specifically a part photo sample of the corresponding part category. For example, one of the part sample sets 22' is 1-way 8-shot speaker part samples (including eight speaker part photo samples, which may be based on part category parts of the same model or part category parts of different models). One of the part sample sets 22' is 11-way 1-shot universal part samples (including 11 part categories such as Battery, Screen, Fan, Keyboard and Memory, where each part category has one part photo sample). In some embodiments, each part sample set 22' is related to one part category, and the part categories corresponding to the part sample sets 22' do not duplicate each other. In some embodiments, one part sample set 22' is related to multiple part categories.

In step S404, the prompt engine 31 inputs the product part assembly diagram 5, the prompt content 6, and the part sample sets 22' into a large language model 32 such that the large language model 32 performs part identification on the product part assembly diagram 5 in accordance with the prompt content 6 and based on the few shot learning. The few shot learning compares the support sets with an image to be identified so as to infer the closest support set as the reasoning result. For example, if a part image 51 in the product part assembly diagram 5 is closest to the part demonstration image of a certain support set, then the part demonstration name of this support set is the reasoning result of this part image 51.

In step S405, the prompt engine 31 obtains a generated content returned by the large language model 32. FIG. 6 is a schematic diagram of the generated content according to an embodiment of the disclosure. The generated content includes the assembly guidance 7. The assembly guidance 7 includes a plurality of part assembly steps 71 (here 2.1 to 2.14 as an example). Each part assembly step 71 specifies a part name and an installation location thereof.

Referring to FIG. 5, in some embodiments, the prompt content 6 includes a plurality of description blocks (here 61 to 66 as an example), which are respectively described as follows:

The description block 61 defines a role to perform a task, and as an example, it defines the role as a motherboard assembly technician.

The description block 62 describes task requirements, and as an example, it requires generating the assembly guidance 7 based on the product part assembly diagram 5 and also requires identifying a part name of the part image 51 and an item number 55 (slot) of a corresponding assembly step thereof.

The description block 63 defines constraints of the task, and as an example, it requires that the assembly guidance 7 must have part names and installation locations (slots), requires sequences of part of the part assembly steps (for example, installing the battery needs to be the last step, and installing the motherboard to the shell needs to be the first step), and requires that all the slots need to be identified.

The description block 64 defines input data as images of the motherboard and parts (i.e., the product part assembly diagram 5). In some embodiments, if the large language model 32 is a multi-modal model, then the product part assembly diagram 5 may be directly inputted into the large language model 32, or the description block 64 is embedded into a storage location (e.g., website) of the product part assembly diagram 5 such that the large language model 32 processes and analyzes the images. In some embodiments, if the large language model 32 is capable of processing data only in a text modality, then the large language model 32 further introduces an image processing model (e.g., CNN model). First, the image processing model analyzes the images and extracts features, and the extracted features are converted into text and then provided to the large language model 32 for reasoning.

The description block 65 defines an output format, and as an example, the description block 65 includes an output template such that the assembly guidance 7 conforms to the output template. Here, it is required to output the content according to items, and each step item lists each part name and the installation location thereof. In addition, it also indicates the content of the first step item and the last step item.

The description block 66 defines other constraints, and as an example, it defines the number of the step items, requires identifying the part name and the corresponding installation number according to the product part assembly diagram 5, requires that the output content is only the assembly guidance 7 without additional information, and requires part of the identified part names to be renamed as a unified name such that the part names in each assembly guidance 7 are consistent.

As shown in FIG. 6, in some embodiments, in the assembly guidance 7 generated by the large language model 32, each part assembly step 71 specifies a part name (e.g., Heatsink, Fan or Keyboard) to be assembled to a motherboard. As can be seen, the assembly guidance 7 conforms to the output template (description block 65) in FIG. 5. In some embodiments, the input/output unit 12 further provides an editing interface (not shown) for technicians to check the content of the assembly guidance 7 generated by the large language model 32 and edit the part of the content that does not conform to the output template or the product part assembly diagram 5.

As shown in FIG. 4, in some embodiments, the motherboard image 52 further includes a plurality of slot marks 53, and each slot mark 53 corresponds to one slot on the motherboard image 52 and one part image 51. Specifically, a mark line 54 is added to the product part assembly diagram 5 to connect the slot and the corresponding part image 51, and a frame line is added around this slot as a slot mark 53, so that the assembler can carry out the assembly operation according to the assembly guidance 7. In addition, a plurality of item numbers 55 adjacent to the corresponding part images 51 are further marked on the product part assembly diagram 5 such that the large language model 32 can infer the part names for the corresponding part images 51 and identify the numbers for the item numbers 55, thereby placing the inferred part names to the step items with the corresponding adjacent item numbers 55. For example, the part name identified from the part image 51 with the adjacent item number 55 of "2.2" is placed into the part assembly step 71 with the step item of "2.2".

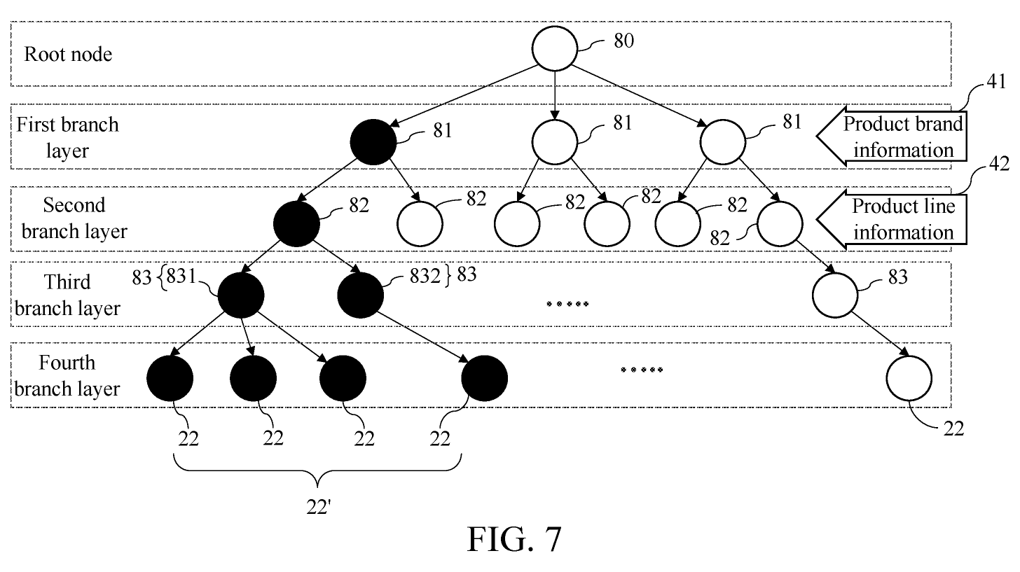

FIG. 7 is a schematic diagram of a tree structure of candidate sample sets 22 according to an embodiment of the disclosure. In some embodiments, the plurality of candidate sample sets 22 described above are stored in the storage unit 11 based on the form of a tree structure. As an example, the tree structure extends from a root node 80 with four layers, namely the first to fourth branch layers, which are respectively described as follows:

The first branch layer forms a plurality of first branch points 81 extending from the root node 80 based on a product brand attribute. Therefore, each first branch point 81 represents a different product brand.

The second branch layer forms a plurality of second branch points 82 based on a product line attribute, and each second branch point 82 is derived from one of the first branch points 81. Therefore, each second branch point 82 represents a product line under a certain product brand. For example, a notebook computer and a desktop computer are of different product lines.

The third branch layer forms a plurality of third branch points 83 based on a generality attribute, and each third branch point 83 is derived from one of the second branch points 82 and connected to at least one candidate sample set 22. The candidate sample sets 22 are located on the fourth branch layer (i.e., the bottom layer of the tree structure). For example, the third branch points 83 are categorized as general and special according to the generality attribute. Some candidate sample sets 22 are connected to the third branch points 831 representing general, and some candidate sample sets 22 are connected to the third branch points 832 representing special.

Although the four-layer tree structure has been described above, the tree structure of the candidate sample sets 22 in the embodiments of the disclosure is not limited to four layers, and it may have more or less layers. Besides, the branch points in the embodiments of the disclosure are not limited to the branch attributes described above.

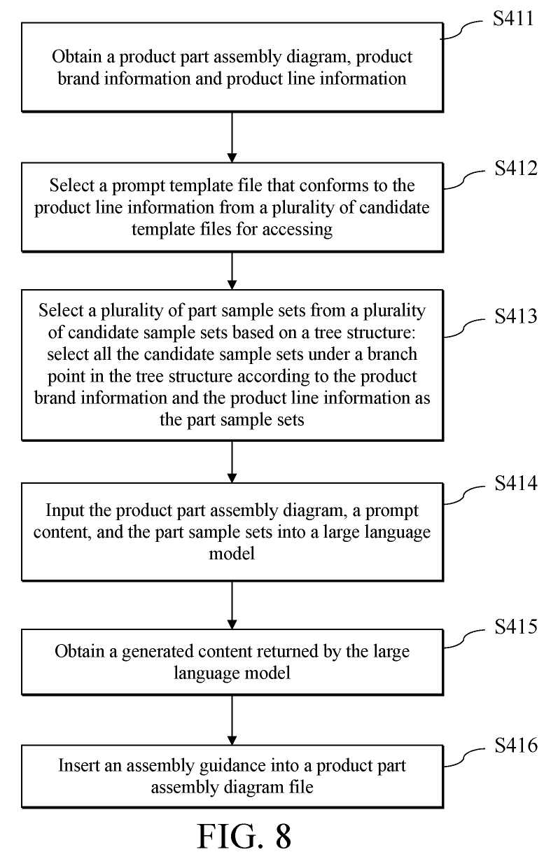

FIG. 8 is a flowchart of a method for generating an assembly guidance 7 for a product part assembly diagram 5 according to an embodiment of the disclosure, which includes step S411 to step S416. Step S414 and step S415 are respectively the same as step S404 and step S405 in FIG. 3 described above and will not be repeated here. The following describes the differences in other steps:

Step S411 is different from step S401 described above in further including obtaining product brand information 41 and product line information 42. As shown in FIG. 1, the product brand information 41 and the product line information 42 are obtained via the input/output unit 12.

Step S412 is different from step S402 described above in further defining the step of accessing a prompt template file 21', i.e., selecting a prompt template file 21' that conforms to the product line information 42 from a plurality of candidate template files 21 for accessing, so as to select an appropriate one from the candidate template files 21 to obtain the prompt content 6 of a product line suitable for the product part assembly diagram 5 for subsequent use in step S414.

Step S413 is different from step S403 described above in further defining the step of obtaining the plurality of part sample sets 22', i.e., selecting the part sample sets 22' from the plurality of candidate sample sets 22 based on the tree structure. More specifically, step S413 is selecting all the candidate sample sets 22 under a branch point in the tree structure according to the product brand information 41 and the product line information 42 as the part sample sets 22'. As shown in FIG. 7, the conforming first branch point 81 and second branch point 82 (filled with black) are selected according to the obtained product brand information 41 and product line information 42, third branch points 83 (filled with black) thereunder are also selected, and the candidate sample sets 22 extending from these third branch points 83 are the selected part sample sets 22' (filled with black) for subsequent use in step S414. By using the tree structure, the candidate sample sets 22 within a specific range can be selected for few shot learning, and there is no need to use all the candidate sample sets 22, which can reduce processing procedures and help in making the generated results more accurate, and can also help in finding out which candidate sample set 22 is the cause of the problem when the generated results are not as expected.

In addition, in some embodiments, the method for generating an assembly guidance 7 for a product part assembly diagram 5 further includes step S416, i.e., inserting the assembly guidance 7 into a product part assembly diagram file for subsequent assemblers to follow when performing the assembly operation. In some embodiments, the product part assembly diagram file further includes the product part assembly diagram 5 in addition to the assembly guidance 7. In some embodiments, the product part assembly diagram file is stored in the storage unit 11. In some embodiments, the product part assembly diagram file is outputted via the input/output unit 12.

When the method for generating an assembly guidance 7 for a product part assembly diagram 5 according to some embodiments of the disclosure is actually applied to the production line, compared with the manual writing of the assembly guidance 7, the accuracy rate can reach 78.3% (the accuracy rate of part names listed by the assembly guidance 7). Moreover, compared with the manual writing of the assembly guidance 7, the method for generating an assembly guidance 7 for a product part assembly diagram 5 according to some embodiments of the disclosure shortens the writing time of the assembly guidance 7 and can improve the efficiency by 73%.

In some embodiments, the storage unit 11 includes one or more non-transitory storage media. Examples of non-transitory storage media include, but not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other internal memory technologies, a compact disc read-only memory (CD-ROM), a digital versatile disc (DVD) or other optical storages, a magnetic cassette tape, a magnetic tape disc storage or other magnetic storage apparatuses, or any other non-transmission media, which can be used for storing information that can be accessed by computing apparatuses. As defined herein, non-transitory storage media do not include transitory media, such as modulated data signals and carriers.

In some embodiments, the input/output unit 12 has the ability to input and output information, and includes at least one of input devices such as a keyboard, a mouse, a speech input device (including an audio input device such as a microphone), a touch screen and a communication device (which supports wired communication or/and wireless communication protocols such as the Internet or a local area network), and at least one of output devices such as a display, a speech output device (including a voice output device such as a speaker) and a communication device (which supports wired communication or/and wireless communication protocols such as the Internet or a local area network). The input devices and the output devices further operate in conjunction with corresponding software (e.g. firmware, drivers, applications, application programming interfaces or/and graphical user interfaces).

In some embodiments, the computing unit 13 is an integrated circuit chip, including at least one of programmable computing devices such as a central processing unit (CPU), a graphics processing unit (GPU) a tensor processing unit, a digital signal processor (DSP), an application specific integrated circuit (ASIC) and a field-programmable gate array (FPGA).

In some embodiments, the electronic device 1 is a computing device such as a personal computer, an industrial computer, a notebook computer, a tablet computer, a smart phone, an embedded system, an edge device or a cloud server.

The method for generating an assembly guidance 7 for a product part assembly diagram 5, the electronic device 1 and the non-transitory computer-readable storage medium according to some embodiments of the disclosure can realize generation of the assembly guidance 7 for the product part assembly diagram 5 by using a small number of samples. In some embodiments, the tree structure is used to store the candidate sample sets 22, which can reduce processing procedures and help in making the generated results more accurate and finding out causes of inaccurate generated results.

What is claimed is:

1. A method for generating an assembly guidance for a product part assembly diagram, comprising:
obtaining a product part assembly diagram and a plurality of part sample sets;
inputting the product part assembly diagram, a prompt content, and the part sample sets into a large language model; and
obtaining a generated content returned by the large language model, wherein the generated content comprises an assembly guidance with a plurality of part assembly steps.

2. The method for generating an assembly guidance for a product part assembly diagram according to claim 1, wherein the obtaining the part sample sets is selecting the part sample sets from a plurality of candidate sample sets based on a tree structure.

3. The method for generating an assembly guidance for a product part assembly diagram according to claim 2, wherein the candidate sample sets are located at a bottom layer of the tree structure.

4. The method for generating an assembly guidance for a product part assembly diagram according to claim 3, further comprising:
obtaining product brand information and product line information,
wherein the step of selecting the part sample sets from the candidate sample sets based on the tree structure is selecting all the candidate sample sets under a branch point in the tree structure according to the product brand information and the product line information as the part sample sets.

5. The method for generating an assembly guidance for a product part assembly diagram according to claim 3, wherein the tree structure further comprises a first branch layer, the first branch layer forming a plurality of first branch points based on a product brand attribute.

6. The method for generating an assembly guidance for a product part assembly diagram according to claim 5, wherein the tree structure further comprises a second branch layer, the second branch layer forming a plurality of second branch points based on a product line attribute, and each of the second branch points being derived from one of the first branch points.

7. The method for generating an assembly guidance for a product part assembly diagram according to claim 6, wherein the tree structure further comprises a third branch layer, the third branch layer forming a plurality of third branch points based on a generality attribute, and each of the third branch points being derived from one of the second branch points and connected to at least one of the candidate sample sets.

8. The method for generating an assembly guidance for a product part assembly diagram according to claim 1, further comprising:
obtaining product line information; and
selecting a prompt template file that conforms to the product line information from a plurality of candidate template files for accessing to obtain the prompt content of the prompt template file.

9. The method for generating an assembly guidance for a product part assembly diagram according to claim 1, wherein the prompt content comprises an output template, and the assembly guidance conforms to the output template.

10. The method for generating an assembly guidance for a product part assembly diagram according to claim 9, wherein each of the part assembly steps is to specify a part name to be assembled to a motherboard.

11. The method for generating an assembly guidance for a product part assembly diagram according to claim 1, wherein the prompt content further requires identifying a part name and a corresponding item number thereof from a plurality of part images in the product part assembly diagram.

12. The method for generating an assembly guidance for a product part assembly diagram according to claim 11, wherein the prompt content further requires part of the identified part names to be renamed as a unified name.

13. The method for generating an assembly guidance for a product part assembly diagram according to claim 1, wherein the prompt content further requires sequences of part of the part assembly steps.

14. The method for generating an assembly guidance for a product part assembly diagram according to claim 1, further comprising:
inserting the assembly guidance into a product part assembly diagram file.

15. The method for generating an assembly guidance for a product part assembly diagram according to claim 1, wherein each of the part sample sets comprises at least one part demonstration name and at least one corresponding part demonstration image.

16. A non-transitory computer-readable storage medium, storing a plurality of instructions loaded to execute the method for generating an assembly guidance for a product part assembly diagram according to claim 1.

17. An electronic device, comprising:
a storage unit, storing a plurality of part sample sets;
an input/output unit, obtaining a product part assembly diagram; and
a computing unit, coupled to the storage unit and the input/output unit, inputting the product part assembly diagram, a prompt content, and the part sample sets to a large language model, and obtaining a generated content returned by the large language model, wherein the generated content comprises an assembly guidance, and the assembly guidance comprises a plurality of part assembly steps and is outputted via the input/output unit.

18. The electronic device according to claim 17, wherein the part sample sets are selected from a plurality of candidate sample sets stored based on the form of a tree structure.

19. The electronic device according to claim 18, wherein the input/output unit further obtains product brand information and product line information, and the computing unit selects all the candidate sample sets under a branch point in the tree structure according to the product brand information and the product line information as the part sample sets.

20. The electronic device according to claim 17, wherein the input/output unit further obtains product line information, and the computing unit selects a prompt template file that conforms to the product line information from a plurality of template files for accessing.
